(19) United States
(12) Patent Application Publication
(10) Pub. No.: US 2009/0314410 A1
(43) Pub. Date: Dec. 24, 2009

(54) TACTILE SENSOR HAVING MEMBRANE STRUCTURE AND MANUFACTURING METHOD THEREOF

(75) Inventors: Jong Ho Kim, Daejeon (KR); Yon Kyu Park, Daejeon (KR); Min Seok Kim, Daejeon (KR); Jae Hyuk Choi, Daejeon (KR); Dae Im Kang, Daejeon (KR)

Correspondence Address: AKERMAN SENTERFITT, P.O. BOX 3188, WEST PALM BEACH, FL, 33402-3188, US

(73) Assignee: Korea Research Institute of Standards and Science, Daejeon (KR)

(21) Appl. No.: 12/245,042

(22) Filed: Oct. 3, 2008

(30) Foreign Application Priority Data
Jun. 20, 2008 (KR) 10-2008-0058138

(51) Int. Cl. B32B 37/00; G01L 1/00

(52) U.S. Cl. 156/60; 73/862.68

(57) ABSTRACT

The present invention relates to a sensor capable of sensing temperature or force applied by a user. According to an aspect of the present invention, the tactile sensor includes a polymer layer having a concave portion and a membrane on a lower portion, wherein the membrane is formed by a concave portion, a resistant layer formed on a part of the polymer layer, and a conduction layer formed around the resistant layer. According to another aspect of the present invention, the tactile sensor includes a first polymer layer, a resistant layer formed on a part of the first polymer layer, a conduction layer formed around the resistant layer, a second polymer layer provided over the conduction layer and having a concave portion formed therein, and a base layer connected to the second polymer layer.

### BACKGROUND OF THE INVENTION

1. Field of the Invention

The present invention relates to a sensor capable of sensing temperature or force applied by a user, and more particularly, to a tactile sensor having a membrane structure, thus providing excellent performance, and having a resistant layer formed therein using a screen printing method, thereby facilitating fabrication, and a method of manufacturing the same.

2. Background of the Related Art

In general, a tactile sensor is a biomimetric type sensor that is able to sense information of ambient environments, such as contact force, vibration, surface roughness and a temperature change relative to thermal conductivity.

A conventional tactile sensor was fabricated using a semiconductor substrate, such as a silicon substrate, by employing Micro Electro-Mechanical System (MEMS) technology and did not secure sufficient flexibility.

Korean Patent Application No. 10-2005-0102261, which was filed by improving the above problem, provides a tactile sensor with secured flexibility. However, this tactile sensor used a print or semiconductor process in order to form resistant material being piezoresistance (for example, Ni—Cr) material and a membrane structure and was problematic in that it had a complicated manufacturing method.

Further, there has been a need for a new tactile sensor and a method of manufacturing the same because of the problem of a reduction in productivity, such as low production efficiency due to the complicated manufacturing method.

### SUMMARY OF THE INVENTION

Accordingly, the present invention has been made in view of the above problems occurring in the prior art, and it is an object of the present invention to provide a tactile sensor having a membrane structure, thus providing linearity and low hysteresis.

It is another object of the present invention to provide a tactile sensor having resistant material formed using a screen printing method not an existing semiconductor process, thereby providing easy fabrication and excellent productivity, and a method of manufacturing the same.

To achieve the above objects, a tactile sensor having a membrane structure according to an aspect of the present invention includes a polymer layer having a concave portion and a membrane on a lower portion, wherein the membrane is formed by a concave portion, a resistant layer formed on a part of the polymer layer, and a conduction layer formed around the resistant layer.

The polymer layer includes a first polymer layer, a second polymer layer provided on one side of the first polymer layer and having a specific location perforated therethrough, thus forming the concave portion of the polymer layer, and a first adhesive layer adhering the first polymer layer and the second polymer layer together.

To achieve the above objects, a tactile sensor having a membrane structure according to another aspect of the present invention, includes a first polymer layer, a resistant layer formed on a part of the first polymer layer, a conduction layer formed around the resistant layer, a second polymer layer provided over the conduction layer and having a concave portion formed therein, and a base layer connected to the second polymer layer, wherein the membrane structure is formed by the concave portion.

The concave portion and the resistant layer are placed on the same axial line.

The first polymer layer and the second polymer layer are formed of the same material.

The first polymer layer and the second polymer layer are formed of a polyimide film or a polyester film.

The resistant layer has a thickness thicker than that of the conduction layer, and the resistant layer has a cross section of a ‘T’ shape.

The resistant layer is formed of conductive ink or conductive paste.

The polymer layer further includes a base layer.

A protection layer formed over the resistant layer and the conduction layer is further included.

A signal processor for outputting a resistance signal change of the resistant layer is further included. The signal processor detects the resistance signal change according to the following Equation.

$$Δ E = \frac{[ r / {( 1 + r )}^{2} ] ( - Δ R 2 / R 2 )}{1 + [ 1 / ( 1 + r ) ] [ r ( Δ R 2 / R 2 ) ]} V \qquad [ Equation ]$$

(where r=R2/R1, R2 is resistance of the resistant layer, ΔR2 is a change in the resistance of the resistant layer, and R1 is equivalent resistance of the signal processor)

The concave portion can be filled with elastomer having stiffness lower than that of the polymer layer.

The elastomer can include silicon or polyurethane.

To achieve the above objects, a method of manufacturing a tactile sensor having a membrane structure according to still another aspect of the present invention includes the steps of forming a conduction layer so that a part of a first polymer layer is exposed in a first polymer layer, forming a resistant layer in the part of the first polymer layer, and adhering a second polymer layer, which has a specific location perforated therethrough, to the first polymer layer or the conduction layer, forming a membrane structure.

After the step of forming the membrane structure, the step of forming a base layer over the second polymer layer is further included.

In the step of forming the membrane structure, in the case in which the first polymer layer and the second adhesive layer are formed, the step of forming a protection layer over the resistant layer and the conduction layer is further included.

When the base layer is formed, a concave portion is filled with elastomer having stiffness smaller than that of the first polymer layer or the second polymer layer.

### BRIEF DESCRIPTION OF THE DRAWINGS

Further objects and advantages of the invention can be more fully understood from the following detailed description taken in conjunction with the accompanying drawings in which:

FIG. 1 is a lateral sectional view of a first embodiment of a tactile sensor having a membrane structure in accordance with the present invention;

FIG. 2 is a state diagram in which specific force is applied to the membrane structure in accordance with the present invention;

FIG. 3 is a first equivalent circuit diagram of a signal processor and a resistant layer in accordance with the present invention;

FIG. 4 is a lateral sectional view of a second embodiment of a tactile sensor having a membrane structure in accordance with the present invention;

FIGS. 5 to 11 are process state diagrams of respective steps according to a method of manufacturing the tactile sensor having the membrane structure in accordance with the present invention; and

FIG. 12 is a second equivalent circuit diagram of a signal processor and a resistant layer in accordance with the present invention.

### DETAILED DESCRIPTION OF THE PREFERRED EMBODIMENT

The present invention will now be described in detail in connection with specific embodiments with reference to the accompanying drawings.

<Tactile Sensor Having Membrane Structure>

### First Embodiment

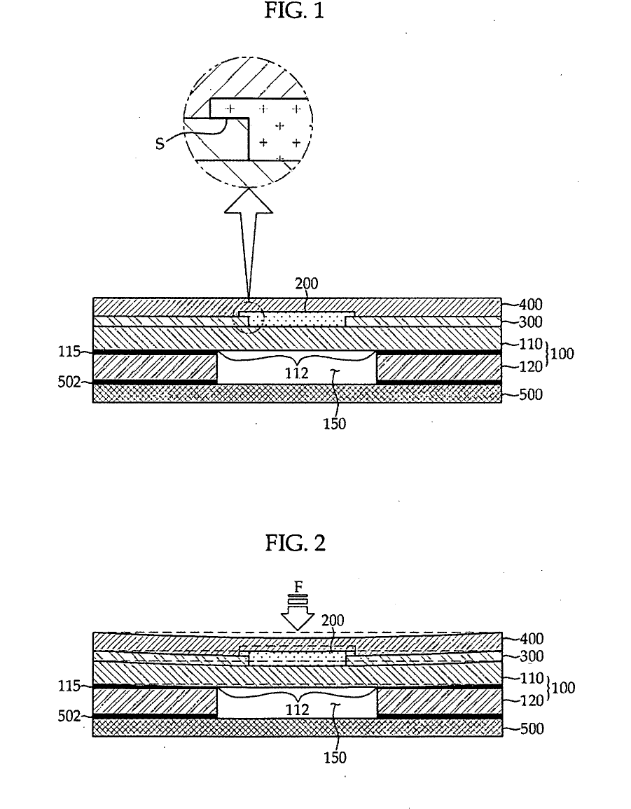

A tactile sensor having a membrane structure according to the present invention includes, as shown in FIG. 1, a polymer layer 100, a resistant layer 200, a conduction layer 300 and so on.

The polymer layer 100 has a concave portion 150 formed at a bottom and has a membrane (112) structure. This concave portion 150 and the membrane (112) structure can be formed by adhering a first polymer layer 110 and a second polymer layer 120. The first polymer layer 110 is formed on the upper side of the structure, and the second polymer layer 120 is formed on the lower side of the structure. The first polymer layer 110 and the second polymer layer 120 are adhered by a first adhesive layer 115. Here, the second polymer layer 120 has a specific location perforated therethrough, and the concave portion 150 is formed in the location of the second polymer layer 120. A method of forming the concave portion 150 can include, for example, punching. The first adhesive layer 115 can be formed using a foam tape, a double-sided tape, a thermal adhesive tape, polymer adhesives or the like. The membrane 112 can have any cross section such a circle or a square.

The polymer layer 100 his a polymer layer, such as a polyimide film or a polyester film, and has a specific thickness. In particular, the polyimide film has ultra-high heat-resistant and ultra-high cool-resistant properties, which can withstand high temperature of 400□ or more or low temperature of minus 265□. The polyimide film is also advantageous in that it has a thin thickness and excellent flexibility. Further, the polyimide film is advantageous in that it has chemical-resistant and abrasion-resistant properties and therefore can diversify the industry fields employing the tactile sensor of the present invention.

Further, the first polymer layer 110 and the second polymer layer 120, constituting the polymer layer 100, can be formed of the same material, and the first polymer layer 110 and the second polymer layer 120 can become a polyimide film or a polyester film. The resistant layer 200 is preferably comprised of conductive ink or conductive paste. The conductive ink or conductive paste includes conductive particles, such as carbon, carbon nanotube (CNT) and carbon black, and has its resistance changed as the distance between carbon particles is changed when experiencing external physical influences (for example, a user's force).

The resistant layer 200 is formed in a part of the polymer layer 100, as shown in FIG. 1. In particular, FIG. 1 shows that the resistant layer 200 is formed on the polymer layer 100. Moreover, the cross section of the membrane 112 can preferably have a ‘T’ shape. The thickness of the resistant layer 200 is thicker than that of the conduction layer 300 and has an upper diameter larger than a lower diameter. Since the upper diameter of the resistant layer 200 is wider than the lower diameter thereof, a contact area ‘S’ of the resistant layer 200 with the conduction layer 300 can be wide. Further, an effect in which the linearity of a resistance signal change at the edge portion of the resistant layer 200 is reduced can be minimized. The resistant layer 200 can have any cross section, such as a polyhedron including a circle and a square.

The conduction layer 300 is a location where a signal line is provided. The signal line functions to detect a resistance signal change of the resistant layer 200. The signal line can be formed using a method of plating the signal line with metal or a method of screen-printing metallic paste. The metallic paste can more preferably include silver paste. The signal line can also be formed using a screen printing method employing resistant ink. Here, unlike the resistant ink used for the resistant layer 200, the resistant ink, used in the signal line must have resistance enough to detect a resistance signal change of the resistant layer 200. The signal line formed in the conduction layer 300 is connected to a signal processor to be described later on.

A base layer 500 is preferably formed under the polymer layer 100. The base layer 500 can be formed using several kinds of films, including a polyimide film or a polyester film. The polymer layer 100 and the base layer 500 are adhered by a second adhesive layer 502. The second adhesive layer 502 can be formed using a foam tape, a double-sided tape, a thermal adhesive tape, a polymer adhesives or the like in the same manner as the first adhesive layer 115.

A protection layer 400 for protecting the conduction layer 300 and the resistant layer 200 from external contaminants is preferably provided over the conduction layer 300 and the resistant layer 200. The protection layer 400 can be formed by coating a UV curing agent using a screen printing method and can also be formed by adhering other protection film (a coating film, a polyester film, a polyimide film, etc.).

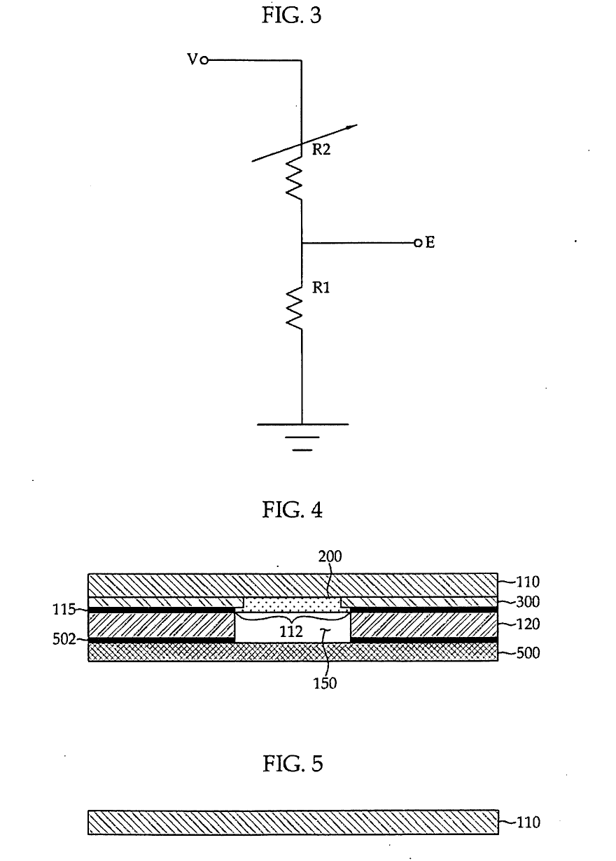

FIG. 2 shows a state where, when a user applies specific force F to the tactile sensor of the present invention, the tactile sensor is deformed. As shown in FIGS. 1 and 2, the resistant layer 200 is preferably located on the same axial line as that of the concave portion 150. That is, the resistant layer 200 is preferably provided over the membrane (112) structure.

Further, the concave portion 150 is preferably filled with elastomer 152 (refer to FIG. 11) having stiffness lower than that of the polymer layer 100, that is, the first polymer layer 110 and the second polymer layer 120. This is for the purpose of protecting the tactile sensor of the present invention from external shock and increasing stability at the time of sensing. If stiffness of the elastomer 152 is identical to or greater than that of the polymer layers 100, 110 and 120, deformation of the tactile sensor as shown in FIG. 2 is not generated. The elastomer 152 can employ, for example, silicon, polyurethane or the like.

When a user applies specific force as shown in FIG. 2, the resistance of the resistant layer 200 is changed. Accordingly, it is preferred that a signal processor (not shown) for processing a change in the resistance signal be further included.

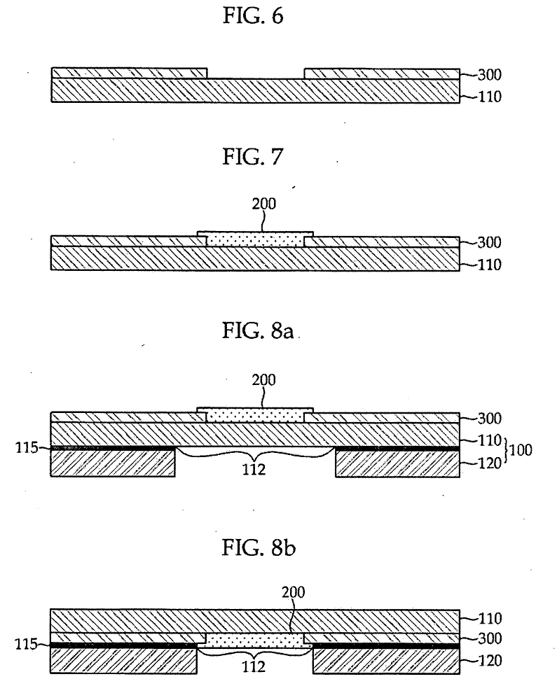

FIG. 3 shows an equivalent circuit in the case in which the signal processor is included. R1 denotes equivalent resistance of the circuit included in the signal processor, and R₂ denotes variable resistance of the circuit, which varies according to force applied by a user due to resistance of the resistant layer 200. V denotes a voltage value of an external voltage source for detecting a change in the resistant layer 200 as voltage. E denotes an output voltage of the signal processor, and ΔE denotes the amount of change in the output voltage of a signal output unit for detecting a change in the resistance of the resistant layer 200.

When specific force is not applied to the resistant layer 200, the output voltage can be expressed by the following Equation 1.

$$E = \frac{R 1}{R 1 + R 2} V \qquad [ Equation 1 ]$$

When specific force is applied to the tactile sensor, the resistance value of the resistant layer 200 is changed (ΔR2), so that the output voltage (E+ΔE) of the signal output unit can be expressed by the following Equation 2.

$$E + Δ E = \frac{R 1}{R 1 + R 2 + Δ R 2} V \qquad [ Equation 2 ]$$

Accordingly, ΔE can be found as follows using Equation 1 and Equation 2.

$$Δ E = \frac{[ r / {( 1 + r )}^{2} ] ( - Δ R 2 / R 2 )}{1 + [ 1 / ( 1 + r ) ] [ r ( Δ R 2 / R 2 ) ]} V \qquad [ Equation 3 ]$$

The resistance signal change ΔR2 of the resistant layer 200 can be understood from ΔE shown in Equation 3, and force applied by a user can be measured based on the resistance signal change. Moreover, r is R2/R1.

### Second Embodiment

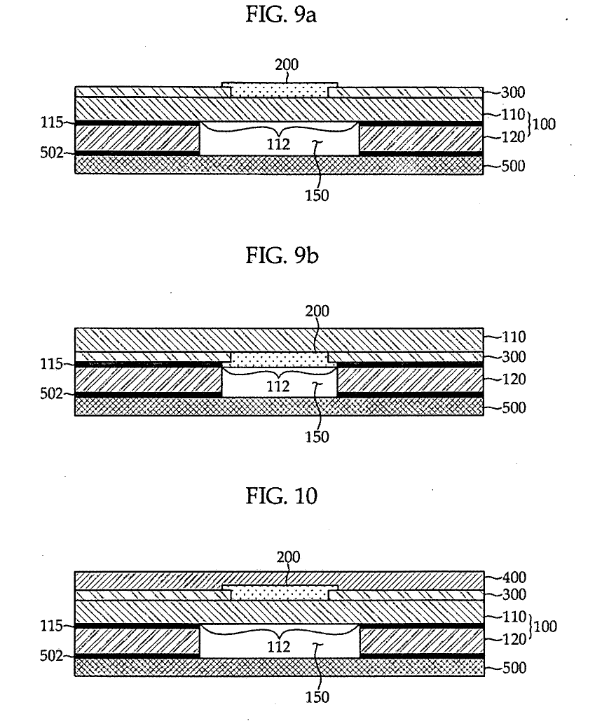

A tactile sensor having a membrane structure according to the present invention can be constructed as shown in FIG. 4. The tactile sensor according to the present embodiment differs from the tactile sensor of the first embodiment in that a second polymer layer 120 having a specific location perforated therethrough is coupled to a conduction layer 300. Further, a concave portion 150 connected to a base layer 500 is formed in the second polymer layer 120, and a membrane (112) structure is formed by a concave portion.

The present embodiment does not need to further include the protection layer 400 since there is no possibility that a resistant layer 200 may be exposed to external contaminants with the help of the base layer 500.

The structures, properties and materials of a first polymer layer 110, the second polymer layer 120, the resistant layer 200, a conductions layer 300, elastomer 152 filled in a concave portion 150, a signal processor and so on, which constitute the tactile sensor of the present embodiment, are identical to those of the first embodiment and detailed description thereof is omitted.

<Method of Manufacturing Tactile Sensor>

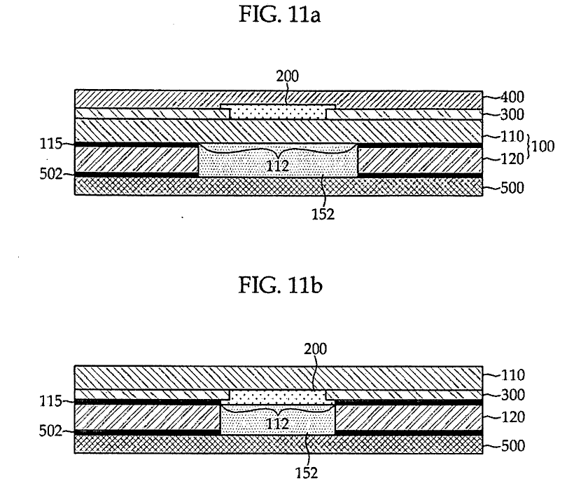

FIGS. 5 to 11 are process state diagrams of respective steps according to a method of manufacturing the tactile sensor having the membrane structure in accordance with the present invention.

First, the conduction layer 300 is formed on the first polymer layer 110 (S100). At this time, as shown in FIG. 6, the conduction layer 300 is formed such that a part of the first polymer layer 110 is exposed. The part of the first polymer layer 110 on which the conduction layer 300 has not been formed becomes a sensing area. The conduction layer 300 is an area in which a signal line for extracting a resistance signal change of the resistant layer 200 is provided. The conduction layer 300 can be formed using a method of plating metal, a method of printing metallic paste (for example, silver paste) or the like.

The resistant layer 200 is then formed (S200). As shown in FIG. 7, the resistant layer 200 is formed in the area of the first polymer layer 110 in which the conduction layer 300 has not been formed. Here, the thickness of the resistant layer 200 is thicker than that of the conduction layer 300 and has an upper diameter larger wider than a lower diameter, so that the resistant layer 200 covers, a part of the conduction layer 300. Accordingly, the cross section of the resistant layer 200 has a ‘T’ shape. The step (S200) of forming the resistant layer 200 is preferably performed using a screen printing method.

Next, the second polymer layer 120 is adhered to the first polymer layer 110 or the conduction layer 300, thus forming a membrane structure, (S300). FIG. 8a shows a state where the second polymer layer 120 is adhered to the first polymer layer 110, and FIG. 8b shows a state where the second polymer layer 120 is adhered to the conduction layer 300. As shown in FIGS. 8a and 8b, the second polymer layer 120 has a specific location perforated therethrough. The perforated portion is an area becoming the concave portion 150 of the tactile sensor. The concave portion 150 constitutes the membrane structure. The second polymer layer 120 is adhered by the first adhesive layer 115 such as a double-sided tape, a thermal adhesive tape, adhesives or the like.

As shown in FIGS. 9a and 9b, the base layer 500 is formed on the second polymer layer 120 (S400) The base layer 500 can be formed using a method of adhering the second adhesives 502 to the bottom of the second polymer layer 120. The second adhesives 502 can also be formed using a double-sided tape, a thermal adhesive tape or various adhesives.

Further, as shown in FIG. 10, the protection layer 400 can be, formed over the resistant layer 200 and the conduction layer 300 (S500). Specific force applied by a user causes a change in a resistance signal. The protection layer 400 functions to protect the resistant layer 200 from external contaminants. The conduction layer 300 also has a signal line for detecting this resistance signal change formed therein and therefore needs to be protected from external contaminants. Accordingly, the protection layer 400 is formed in the event of the first embodiment as shown in FIGS. 8a and 9a. The protection layer 400 can be formed of a coating film, a polyimide film or a polyester film using a screen printing method.

As shown in FIGS. 11a and 11b, in the case in which the base layer 500 is formed, in order to protect the membrane structure being responsible for a sensing function from external shock, the concave portion 150 can be filled with the elastomer 152 having stiffness lower than that of the first polymer layer 110 and the second polymer layer 120. The elastomer 152 can include silicon or polyurethane.

### Modified Example

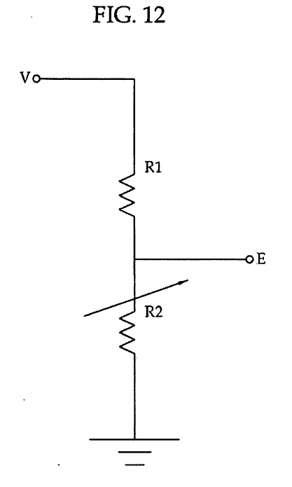

The equivalent circuit of the signal processor and the resistant layer 200 can be constructed as shown in FIG. 12 as well as the construction of FIG. 3.

Further, in the case in which the concave portion 150 is not formed in the polymer layer 100 and the base layer 500 is not provided under the polymer layer 100, the present invention can be utilized as a temperature sensor. Conductive particles of the resistant layer 200, that is, carbon molecules are expanded or contracted according to temperature, causing a change in a resistance signal. Accordingly, the present invention can be utilized as a temperature sensor.

As described above, the tactile sensor having the membrane structure according to the present invention is advantageous in that it can provide a sensor with an excellent quality such as less hysteresis and improved linearity.

Moreover, the present invention is advantageous in that it has a simple manufacturing process, a low production cost, and contribute improved productivity since the resistant layer is formed using a screen printing method.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A tactile sensor having a membrane structure, comprising:
a polymer layer having a concave portion and a membrane on a lower portion, wherein the membrane is formed by a concave portion;
a resistant layer formed on a part of the polymer layer; and
a conduction layer formed around the resistant layer.

2. The tactile sensor as claimed in claim 1, wherein the polymer layer comprises:
a first polymer layer;
a second polymer layer provided on one side of the first polymer layer and having a specific location perforated therethrough, thus forming the concave portion of the polymer layer; and
a first adhesive layer adhering the first polymer layer and the second polymer layer together.

3. A tactile sensor having a membrane structure, comprising:
a first polymer layer;
a resistant layer formed on a part of the first polymer layer;
a conduction layer formed around the resistant layer;
a second polymer layer provided over the conduction layer and having a concave portion formed therein; and
a base layer connected to the second polymer layer,
wherein the membrane structure is formed by the concave portion.

4. The tactile sensor as claimed in claim 1, wherein the concave portion and the resistant layer are placed on the same axial line.

5. The tactile sensor as claimed in claim 3, wherein the concave portion and the resistant layer are placed on the same axial line.

6. The tactile sensor as claimed in claim 2, wherein the first polymer layer and the second polymer layer are formed of the same material.

7. The tactile sensor as claimed in claim 3, wherein the first polymer layer and the second polymer layer are formed of the same material.

8. The tactile sensor as claimed in claim 6, wherein the first polymer layer and the second polymer layer are formed of a polyimide film or a polyester film.

9. The tactile sensor as claimed in claim 7, wherein the first polymer layer and the second polymer layer are formed of a polyimide film or a polyester film.

10. The tactile sensor as claimed in claim 1, wherein:
the resistant layer has a thickness thicker than that of the conduction layer, and
the resistant layer has across section of a ‘T’ shape.

11. The tactile sensor as claimed in claim 3, wherein:
the resistant layer has a thickness thicker than that of the conduction layer; and
the resistant layer has across section of a ‘T’ shape.

12. The tactile sensor as claimed in claim 1, wherein the resistant layer is formed of conductive ink or conductive paste.

13. The tactile sensor as claimed in claim 3, wherein the resistant layer is formed of conductive ink or conductive paste.

14. The tactile sensor as claimed in claim 1, wherein the polymer layer further includes a base layer.

15. The tactile sensor as claimed in claim 1, further comprising a protection layer formed over the resistant layer and the conduction layer.

16. The tactile sensor as claimed in claim 1, further comprising a signal processor for outputting a resistance signal change of the resistant layer,
wherein the signal processor detects the resistance signal change according to the following Equation.
$$Δ E = \frac{[ r / {( 1 + r )}^{2} ] ( - Δ R 2 / R 2 )}{1 + [ 1 / ( 1 + r ) ] [ r ( Δ R 2 / R 2 ) ]} V \qquad [ Equation ]$$
(where r=R2/R1, R2 is resistance of the resistant layer, ΔR2 is a change in the resistance of the resistant layer, and R1 is equivalent resistance of the signal processor)

17. The tactile sensor as claimed in claim 3, further comprising a signal processor for outputting a resistance signal change of the resistant layer,
wherein the signal processor detects the resistance signal change according to the following Equation.
$$Δ E = \frac{[ r / {( 1 + r )}^{2} ] ( - Δ R 2 / R 2 )}{1 + [ 1 / ( 1 + r ) ] [ r ( Δ R 2 / R 2 ) ]} V \qquad [ Equation ]$$
(where r=R2/R1, R2 is resistance of the resistant layer, ΔR2 is a change in the resistance of the resistant layer, and R1 is equivalent resistance of the signal processor)

18. The tactile sensor as claimed in claim 1, wherein the concave portion is filled with elastomer having stiffness lower than that of the polymer layer.

19. The tactile sensor as claimed in claim 3, wherein the concave portion is filled with elastomer having stiffness lower than that of the polymer layer.

20. The tactile sensor as claimed in claim 18, wherein the elastomer includes silicon or polyurethane.

21. The tactile sensor as claimed in claim 19, wherein the elastomer includes silicon or polyurethane.

22. A method of manufacturing a tactile sensor having a membrane structure, the method comprising the steps of:
forming a conduction layer so that a part of a first polymer layer is exposed in a first polymer layer;
forming a resistant layer in the part of the first polymer layer; and
adhering a second polymer layer, which has a specific location perforated therethrough, to the first polymer layer or the conduction layers forming a membrane structure.

23. The method as claimed in claim 22, further comprising the step of forming a base layer over the second polymer layer.

24. The method as claimed in claim 22, further comprising the step of forming a protection layer over the resistant layer and the conduction layer.

25. The method as claimed in claim 23, wherein, when the base layer is formed, the concave portion is filled with elastomer having stiffness smaller than that of the first polymer layer or the second polymer layer.
